(19) United States
(12) Patent Application Publication
(10) Pub. No.: US 2013/0179011 A1
(43) Pub. Date: Jul. 11, 2013

(54) EMERGENCY LANDING ZONE RECOGNITION

(71) Applicants: Steven D. Colby, Owego, NY (US); Stephen C. Moraites, Owego, NY (US)

(72) Inventors: Steven D. Colby, Owego, NY (US); Stephen C. Moraites, Owego, NY (US)

(73) Assignee: Lockheed Martin Corporation, Bethesda, MD (US)

(21) Appl. No.: 13/347,109

(22) Filed: Jan. 10, 2012

(51) Int. Cl. G06F 19/00; G05D 1/00

(52) U.S. Cl. 701/16

(57) ABSTRACT

Systems and methods for automatically identifying one or more candidate emergency landing sites to a pilot of an aircraft are described. The candidate emergency landing sites lie within a current flight-capable range of an aircraft, and may include non-airfield landing sites. The candidate sites may be calculated by an on-board processing system. Various types of data, such as digital terrain elevation data, ground-cover data, hostile-threat data, surface-water data, aircraft parameter data, and flight-obstacle data may be used by an on-board processing system to calculate one or more candidate emergency landing sites suitable for landing the aircraft. A pilot may initiate an emergency landing site identification process during in-flight distress via a button, touch-sensitive screen, or voice-recognition input. The systems and methods may be useful in combat scenarios.

### FIELD OF THE INVENTION

The invention relates to a system, apparatus and methods for identifying possible landing sites for aircraft in emergency situations, e.g., in combat situations when the aircraft has been disabled.

### BACKGROUND

Commercial airlines and most FAA-certified aircraft are currently equipped with “nearest airfield” functionality that can be used by a pilot in the event that an emergency landing is needed. This functionality includes global position system (GPS) that can track an aircraft in flight and a data record of airfields. Should an in-flight emergency occur, the pilot can utilize the nearest airfield system to quickly determine the location of an airfield nearest to the aircraft's current position at which the aircraft may land. Once a nearest airfield is identified by the system, the pilot may alter course to reach the airfield that is the shortest distance from the aircraft. Though available in commercial and private aircraft, nearest airfield systems are not widely proliferated among military aircraft.

### SUMMARY

The present invention relates to systems, apparatus, and methods for identifying one or more candidate emergency landing sites for aircraft in an automated manner, e.g., at the push of a button. The potential landing sites could be at any location on the planet within a range of the aircraft's current position. In response to a pilot request, an on-board processing system can substantially immediately return an identification of one or more candidate emergency landing sites that are within the current flight-range capability of the aircraft, even though the aircraft may be disabled.

Though nearest airfield functionality may be available to some combat aircraft, scenarios can arise during combat missions in which a nearest airfield may not be near enough for the aircraft to reach. For example, an aircraft may become disabled either through enemy fire or through mechanical or equipment failure, and the aircraft may no longer be capable of reaching the nearest airfield. The inventor has recognized and appreciated that in such a situation, the pilot must immediately attend to the task of identifying a suitable landing site for the aircraft, and attention to this task can detrimentally distract the pilot from other important mission tasks or immediate hostile threats. A system that could assist in identifying potential landing sites would benefit the pilot and crew during such emergency situations.

The inventor has recognized that a number of factors must be taken into consideration when seeking an emergency landing site during combat missions. These factors can include without being limited to (1) immediate threats to the crew, (2) location of hostile installations or troops, (3) topography of the land in the vicinity of the aircraft, (4) location of allied installations or troops, (5) flight obstacles (e.g., towers, buildings, wires, and bridges), (6) type of ground cover (e.g., trees, dense vegetation, cleared area, dense cover of large boulders, dense craters or rough terrain), (7) surface water (liquid or frozen), and (8) current status of aircraft operational parameters. The inventor has also recognized that many of these factors are quantifiable and therefore can be processed according to a numerical algorithm to identify to the pilot one or more candidate emergency landing sites. The pilot may, in some implementations, quickly look at the candidate sites and select one for landing the aircraft.

According to one embodiment, a system for recognizing one or more candidate emergency landing sites comprises at least one processor configured to receive an emergency landing request, a first data storage device storing ground-cover information, and the same or a different data storage device storing landing-zone information. The ground-cover information may comprise data identifying ground cover in a region encompassing a pre-planned flight area for the aircraft. The landing-zone information may comprise data identifying at least one non-airfield landing zone in the region suitable in size and evenness of terrain for landing the aircraft. Upon receipt of the emergency request, the at least one processor may be configured to suspend non-critical data processing and identify the at least one candidate emergency landing site within a current flight-capable range of the aircraft. The identification of the at least one candidate landing site may be based at least in part upon the ground-cover information and the landing-zone information.

A method for identifying one or more candidate emergency landing sites for an aircraft may comprise receiving, by at least one processor, an emergency landing request, and suspending, by the at least one processor, non-critical data processing. The method may further comprise identifying, by the at least one processor, at least one candidate non-airfield emergency landing site within a current flight-capable range of the aircraft. The identifying of the candidate landing site may be based, at least in part, upon landing-zone information and ground-cover information within a region encompassing a pre-planned flight area of the aircraft.

The foregoing and other aspects, embodiments, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1A depicts a graphical user-interface display including a soft-key emergency landing zone button, according to one embodiment.

FIG. 1B depicts a hardware emergency landing zone button disposed on an instrument panel, according to one embodiment.

FIG. 2 depicts one embodiment of a processing system on which aspects of the invention may be implemented.

FIG. 3A represents a contour plot of digital terrain elevation data.

FIG. 3B is a graphical representation of ground cover type located in the region that is depicted in FIG. 3A.

FIG. 3C is a graphical representation of surface water located in the region that is depicted in FIG. 3A.

FIG. 3D is a graphical representation of flight obstacles located in the region that is depicted in FIG. 3A.

FIG. 4 represents a flow chart of a method for identifying an emergency landing zone, according to one embodiment.

The features and advantages of the present invention will become more apparent from the detailed description set forth below when taken in conjunction with the drawings.

### DETAILED DESCRIPTION

In overview, the various embodiments of the invention are directed to rapid machine recognition and identification of one or more candidate emergency landing sites within a current flight-capable range of an aircraft in flight. The candidate sites may include both airfield and non-airfield sites suitable for landing the aircraft. In one embodiment, the candidate emergency landing sites may be requested by and presented to a pilot of an aircraft in distress. As one example, the pilot may be operating a helicopter in a combat scenario, during which the helicopter may become disabled and incapable of returning to its base of origin or a pre-planned destination. The candidate emergency landing sites may be calculated by at least one processor based on several different types of informational data, e.g., landing-zone data, ground-cover data, hostile-threat data, surface-water data, flight-obstacle data, and aircraft operational systems data. Emergency landing site recognition and identification according to various embodiments of the invention can provide valuable information to a pilot during in-flight crises situations to assist the pilot in taking necessary actions to increase survivability of the crew and passengers.

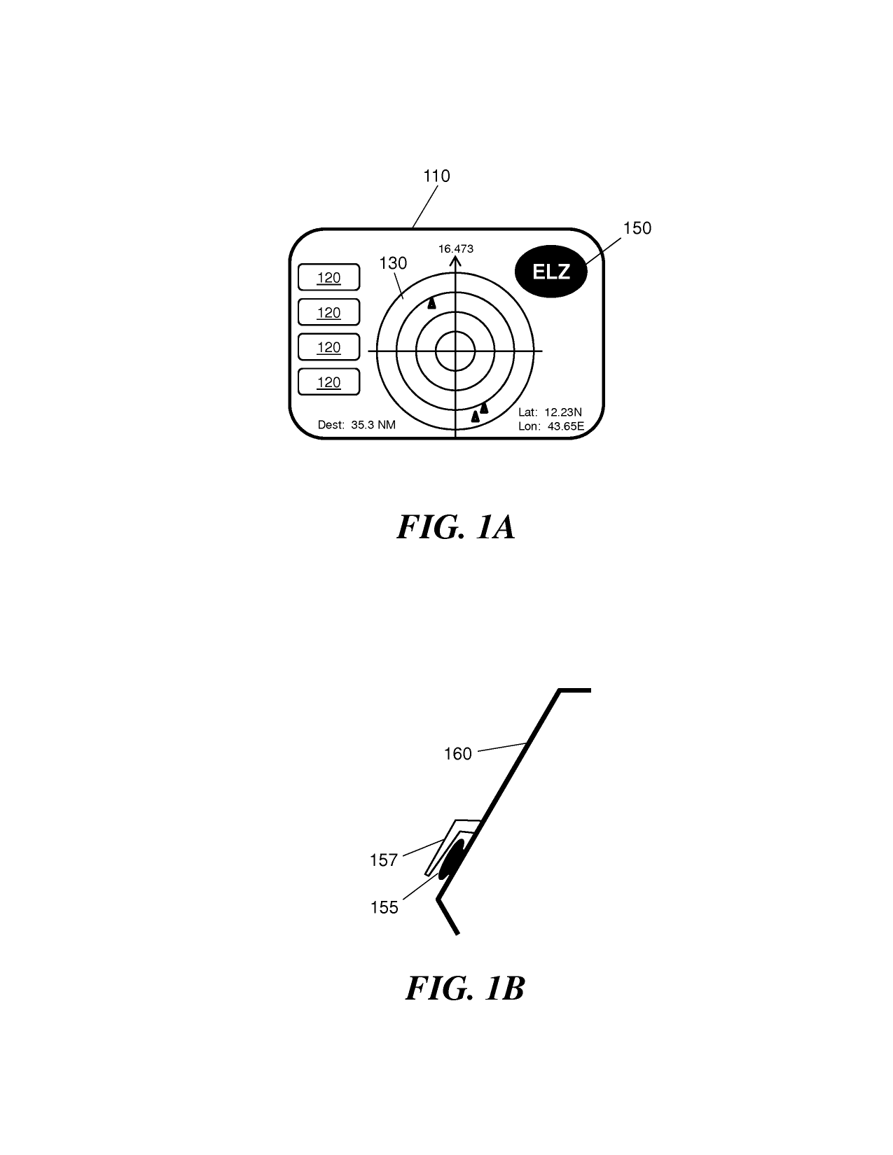

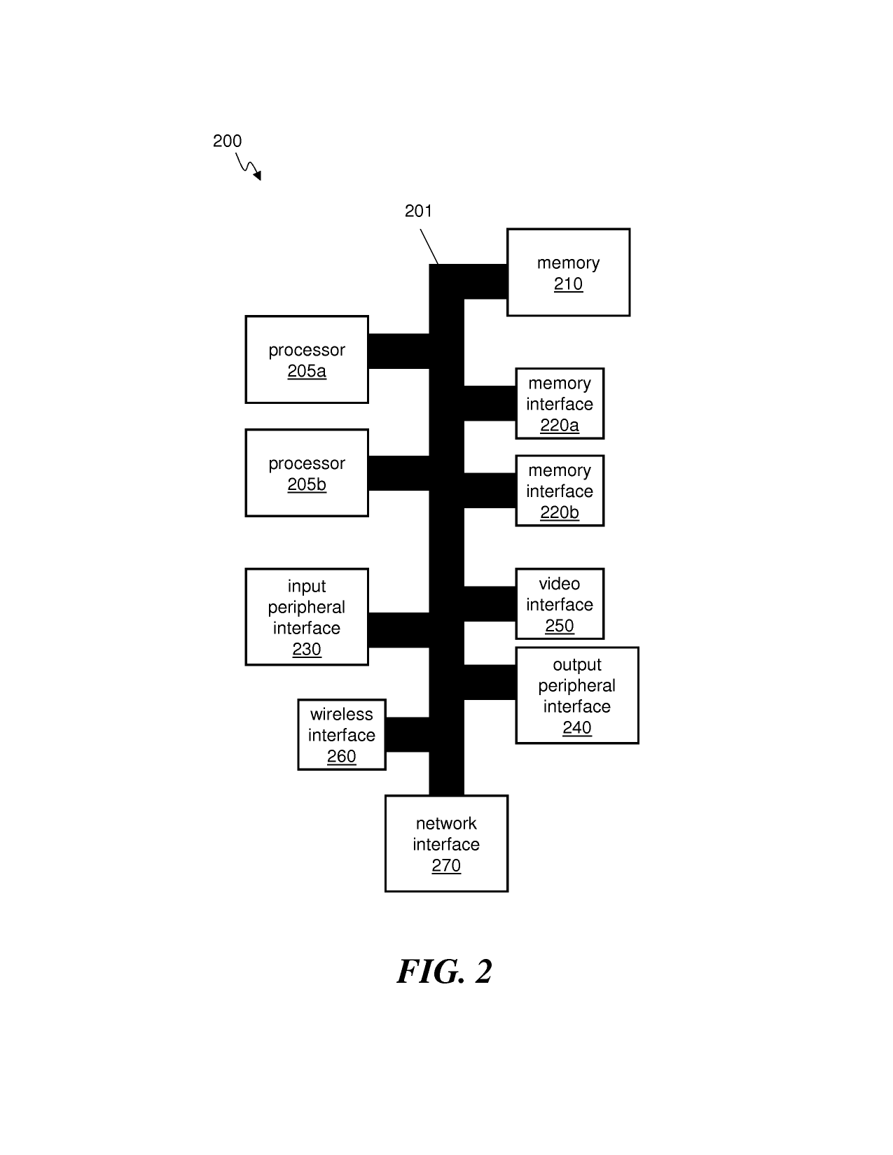

Referring now to FIG. 1A and FIG. 2, these drawings depict one implementation of a system for identifying one or more candidate emergency landing sites. FIG. 1A depicts a video display 110 that may be part of an aircraft's operating console, and FIG. 2 depicts a processing system 200 that may be adapted with machine-readable instructions to execute an algorithm for recognizing one or more candidate emergency landing zone sites in a vicinity of an aircraft in flight. The video display 110 may be located near a pilot or a crew member assisting in operating the aircraft, and may display an interactive emergency landing zone indicator 150 during an in-flight emergency situation. Responsive to the pilot activating the indicator 150 (e.g., by touching the indicator), the processing system 200 may execute an algorithm to recognize and identify to the pilot one or more candidate emergency landing sites suitable for landing the aircraft that are located within a current flight-capable range of the aircraft. The emergency landing sites may be displayed to the pilot on the video display 110 as latitude, longitude coordinates, as points or symbols on a map of the area, or a combination thereof. The pilot or crew member may then choose one of the sites to which to navigate the aircraft.

In some embodiments, an electromechanical button 155 for requesting emergency landing zone identification may be located on an instrument console 160 of the aircraft, as depicted in FIG. 1B. The button 155 may be covered by a protective flip-off or break-through cover 157 that would prevent inadvertent pressing of the button. An aircraft may be equipped with either or both of the indicator 150 and button 155. Though only depicted as a button or indicator, switches or toggles may also be used in substantially equivalent embodiments.

In some embodiments, the aircraft may be equipped with voice-recognition control, such that spoken commands can be recognized by processing system 200. In such embodiments, processing system 200 may recognize a pre-designated command (e.g., “emergency landing,” or “E-L-Z”) as a request to identify candidate emergency landing sites. Responsive to the spoken command, processing system 200 may initiate an emergency landing site process or algorithm to identify one or more nearby landing sites.

The emergency landing zone indicator 150 or button 155 may be presented to a pilot or crew member (e.g., a co-pilot or navigator) of an aircraft according to any one of several conditions. In a first embodiment, the indicator or button may be “always active.” In this embodiment, the indicator 150 or button 155 is always enabled during flight to be activated by the pilot or crew member whenever touched or pressed, so that an emergency landing site algorithm will immediately initiate on processing system 200. In a second embodiment, the indicator or button may only become active and/or be presented to the pilot upon certain conditions during flight of the aircraft. For example, the indicator 150 may only be presented to the pilot on video monitor 110, or button 155 may only become enabled, when processing system 200 determines that the flight-capable range of the aircraft is less than a distance to a base of origin of the aircraft or a planned destination. In some embodiments, the indicator 150 may change color or its presentation (from steady to blinking or vice versa) when the indicator is enabled. In some embodiments, the button 155 may become illuminated when enabled.

When enabled and pressed, indicator 150 or button 155 may initiate execution of an emergency landing site algorithm on processing system 200. The processing system 200 may be configured to receive an emergency landing request as a result of indicator 150 or button 155 being pressed. The request can be in the form of a coded signal or interrupt recognized by an operating system of processing system 200 as a request to initiate the emergency landing site algorithm. The processing system 200 may be further configured to suspend non-critical data processing while executing the emergency landing site algorithm. Upon executing the algorithm processing system may identify at least one candidate emergency non-airfield landing site within a current flight-capable range of the aircraft based at least in part upon landing-zone information and ground-cover information within a region encompassing a pre-planned flight area of the aircraft. The landing-zone information and ground-cover information may be in the form of digital data that is accessible to the processing system. Aspects of identifying one or more emergency landing sites are described in further detail below.

Referring again to FIGS. 1-2 in further detail, video display 110 may be any type and size of video display or monitor that can depict two-dimensional or three-dimensional images. For example, the video display may be a cathode ray tube (CRT) display, liquid crystal display (LCD), light-emitting diode (LED) display, plasma display panel (PDP), or electroluminescent display (ELD). The video display 110 may be configured for interactive operation of processing system 200. For example, the display may include a touch sensitive screen, so that when a displayed feature (e.g., a displayed button 120 or displayed image 150) on the screen is touched by a user, one or more processing algorithms are initiated by processing system 200 responsive to the feature being touched. The video display may be operably connected to processing system 200 through a video interface 250, or in some embodiments through a wireless interface 260.

The processing system 200 illustrates an example of a computing system on which embodiments of emergency landing site recognition and identification may be implemented. The processing system 200 is only one example of a suitable computing environment and is not intended to suggest any limitation as to the scope of use or functionality of various aspects of the invention, as the embodiments of the invention described herein may be used with any computing system including distributed computing systems. Neither should the processing system 200 be interpreted as having any dependency or requirement relating to any one or combination of components illustrated in the exemplary processing system 200.

FIG. 2 illustrates a processing system 200 configured as a general purpose computer that can be adapted with suitable machine-readable instructions to execute an emergency landing size algorithm according to various embodiments of the invention. Components of processing system 200 may include, but are not limited to, at least one processing unit 205a, 205b, a system memory 210, and a system bus 201 that couples various system components including the system memory to the at least one processing unit. Each processing unit 205a, 205b may be a micro-processor. The system bus 201 may be any suitable bus structure, such as a memory bus or memory controller, a peripheral bus, and/or a local bus using any suitable bus architectures. By way of example, and not limitation, such architectures may include any one or combination of the following bus architectures: any type of Ethernet bus (e.g., 10BASE-T, 100BASE-TX, and 1000BASE-T), time-triggered Ethernet bus, Micro Channel Architecture (MCA) bus, Video Electronics Standards Association (VESA) local bus, Scalable Coherent Interface (SCI), Small Computer System Interface (SCSI), and Peripheral Component Interconnect (PCI) bus also known as Mezzanine bus. In some embodiments, one or more components of the processing system 200 may communicate over one or more fiber optic links. The inventors have appreciated that Ethernet communication links are beginning to be used in current aircraft and aviation applications, and recognize that similar and improved communication links may be utilized in various embodiments.

There may be more than one bus of a given type used to configure the processing system 200. Duplicate or redundant communication links may also be employed to provide back-up communication links. Processing system 200 may be embodied in any of a number of forms, such as a rack-mounted computer that is readily removable from the aircraft, or a laptop computer that can be interfaced with a data port on the aircraft.

Processing system 200 may include any one or more of a variety of manufactured computer-readable storage media (such as a hard-disk), or be configured to interface with such media through one or more memory interface ports 220a, 220b. In various embodiments, the computer-readable storage media is non-transitory storage media. Computer-readable storage media can be any suitable media that can be accessed by processing system 200 and includes volatile and nonvolatile storage media, and removable and non-removable storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by processing system 200.

The system memory 210 may include computer storage media in the form of volatile and/or nonvolatile memory such as read only memory (ROM) and random access memory (RAM). A basic input/output system (BIOS), containing the basic routines that help to transfer information between elements within processing system 200, such as during start-up, is typically stored in ROM of memory 210. RAM typically contains data and/or program modules that are immediately accessible to and/or presently being operated on by one or more processors 205a, 205b. By way of example, and not limitation, RAM may include an operating system, application programs, program modules, and program data that may be used and placed in operation on processing system 200.

The processing system 200 may also include other removable/non-removable, volatile/nonvolatile computer storage media. By way of example only, one or more of the following memory drives, in any combination, may be coupled to the processing system 200 at memory interface ports 220a, 220b: hard disk drives that read from or write to non-removable, nonvolatile magnetic storage media; magnetic disk drives that read from or write to a removable, nonvolatile magnetic disk; and optical disk drives that read from or write to a removable, nonvolatile optical disk such as a CD-ROM or other optical storage media. Other removable/non-removable, volatile/nonvolatile computer storage media that can be used in the processing system 200 include, but are not limited to, magnetic tape cassettes, flash memory cards, digital versatile disks, digital video tape, solid state RAM, solid state ROM, and the like. Data from any of the above-mentioned storage media may be accessed by the processing units 205a, 205b through a system bus 201.

The drives and their associated computer storage media, discussed above may provide storage of computer-readable instructions, data structures, program modules and/or other data for adapting the processing system 200 to operate in a specific manner. For example, a hard disk drive may store an operating system, application programs, other program modules, and program data to be used and placed in operation on processing system 200. Note that these components can either be the same as or different from an operating system, application programs, program modules, and program data stored in system RAM.

Processing system 200 may have one or more input and output devices that may be used, among other things, to present a user interface to a user who may interact with and operate processing system 200. Examples of output devices may include one or more video display screens for visual presentation of output, speakers or other sound generating devices for audible presentation of output, and one or more printers or recording devices for producing a permanent record of output. Output devices may be connected via one or more output peripheral interfaces 240. A user may enter commands and information into the processing system 200 through input devices such as a keyboard, a pointing device, commonly referred to as a mouse, trackball or touch pad, a touch screen, and/or a microphone (e.g., via speech-recognition input). Other input devices may include a digitizing tablet, joystick, game pad, satellite dish, scanner, camera, or the like. These and other input devices may be connected to the processing units 205a, 205b through one or more input peripheral interfaces 230 that is coupled to the system bus 201, but may be connected by other interface and bus structures, such as a parallel port, game port or a universal serial bus (USB).

In some embodiments, processing system 200 may operate in a networked environment using one or more logical connections via at least one network interface 270 or a wireless interface 260 to one or more remote computers (not shown in the drawing). A remote computer may be a personal computer, a server, a router, a network PC, a peer device or other type of network node, and may include many or all of the elements described above relative to the processing system 200. Examples of logical connections include, but are not limited to, a local area network (LAN) and a wide area network (WAN), but may also include other networks.

In a networked environment, software applications, data, and program modules, or portions thereof, may be stored in the remote memory storage device (not shown in the drawing). By way of example, and not limitation, data and/or a software application at a remote location (e.g., on a processing system located at a nearby ground station) may be accessed and placed into operation by the processing system 200 via a network link. Software and/or data (e.g., computed results) may be provided to the processing system 200 via the network link.

In some embodiments, processing system 200 may routinely provide data to a remote processing system (e.g., a base station or nearby aircraft) where the remote processing system may have the same or higher computational power than the aircraft's on-board processing system 200. In such a configuration, an emergency landing request may be handled by the remote processing system, and results provided to the processing system 200 via a network link. This may be beneficial in situations where the aircraft's on-board processing system cannot afford to allocate processing time to responding to the emergency landing request.

In operation, processing system 200 may be configured to receive an emergency landing request for information identifying one or more candidate landing sites suitable for landing the aircraft the lie within a current flight-capable range of the aircraft. The emergency landing request may be issued by a pilot or crew member when the pilot or crew member learns that the aircraft has been damaged. Responsive to the request, the processing system 200 may execute an emergency landing site algorithm that identifies to the pilot or crew member one or more candidate landing sites suitable for landing the aircraft the lie within a current flight-capable range of the aircraft. The processing system 200 may be configured to repeatedly execute the emergency landing site algorithm until the aircraft is grounded, since the flight-capable range of the aircraft may vary with time (for example, a fuel or fluid leak or engine temperature increases with time, or secondary damage occurs to the aircraft). The landing sites may include airfield and non-airfield sites.

In some embodiments, the request for emergency landing site information may be initiated by the pilot or a crew member during a time of distress. For example, the aircraft may experience in-flight mechanical failure or suffer battle damage that significantly impairs operation of the aircraft. The pilot or crew member aware of the mechanical failure, which may be indicated by aircraft instrument gauges (e.g., rising engine temperature, dropping oil pressure, dropping fuel level), may initiate a request for emergency landing site information.

In some embodiments, the request for emergency landing site information may be initiated by the processing system 200 automatically based upon sensed operational parameters of the aircraft. For example, the processing system may continuously monitor the flight-capable range of the aircraft based upon fuel and fluid reserves and optionally other factors such as engine operation or engine temperature. Under normal operating conditions, the rate of reduction in the flight-capable range may be determined primarily by the rate of fuel consumption. A sudden change in the rate of reduction of the flight-capable range may be used as a triggering paradigm to issue a request for emergency landing site information automatically by the processing system 200.

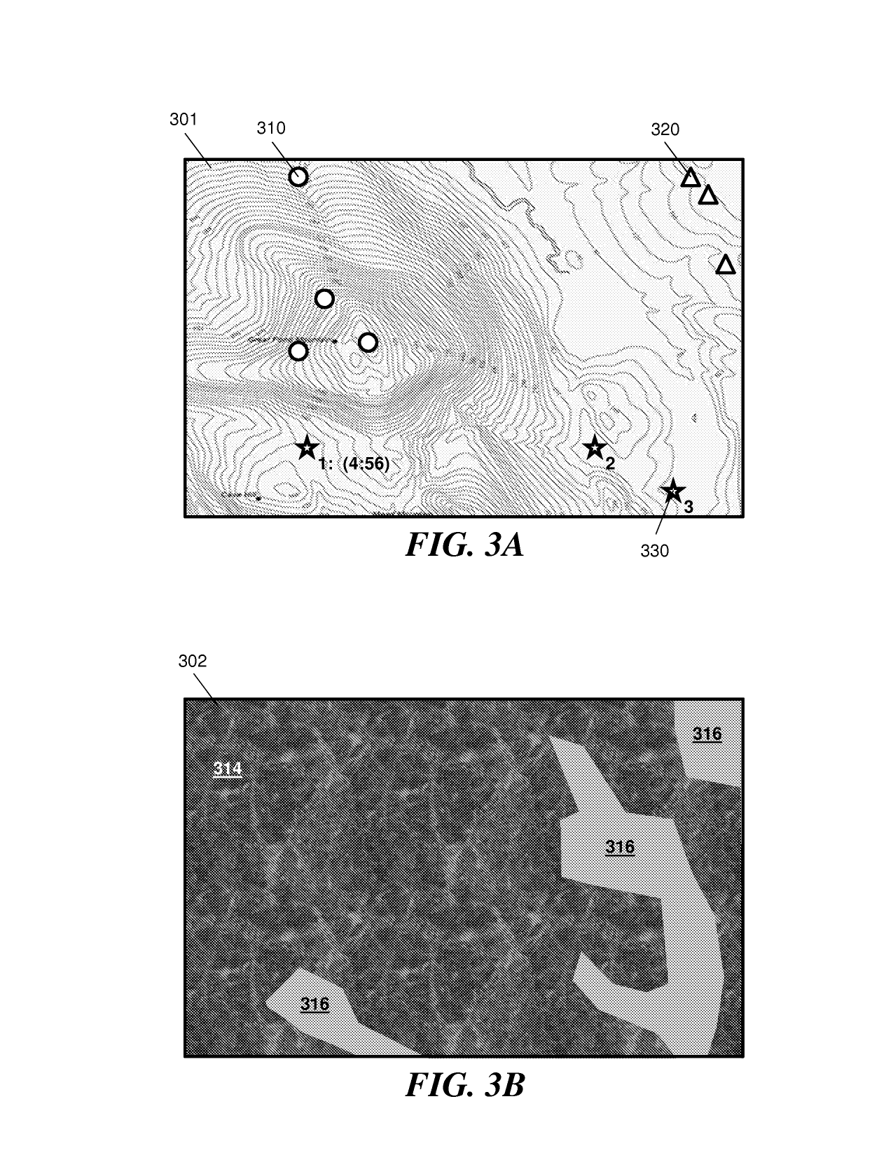

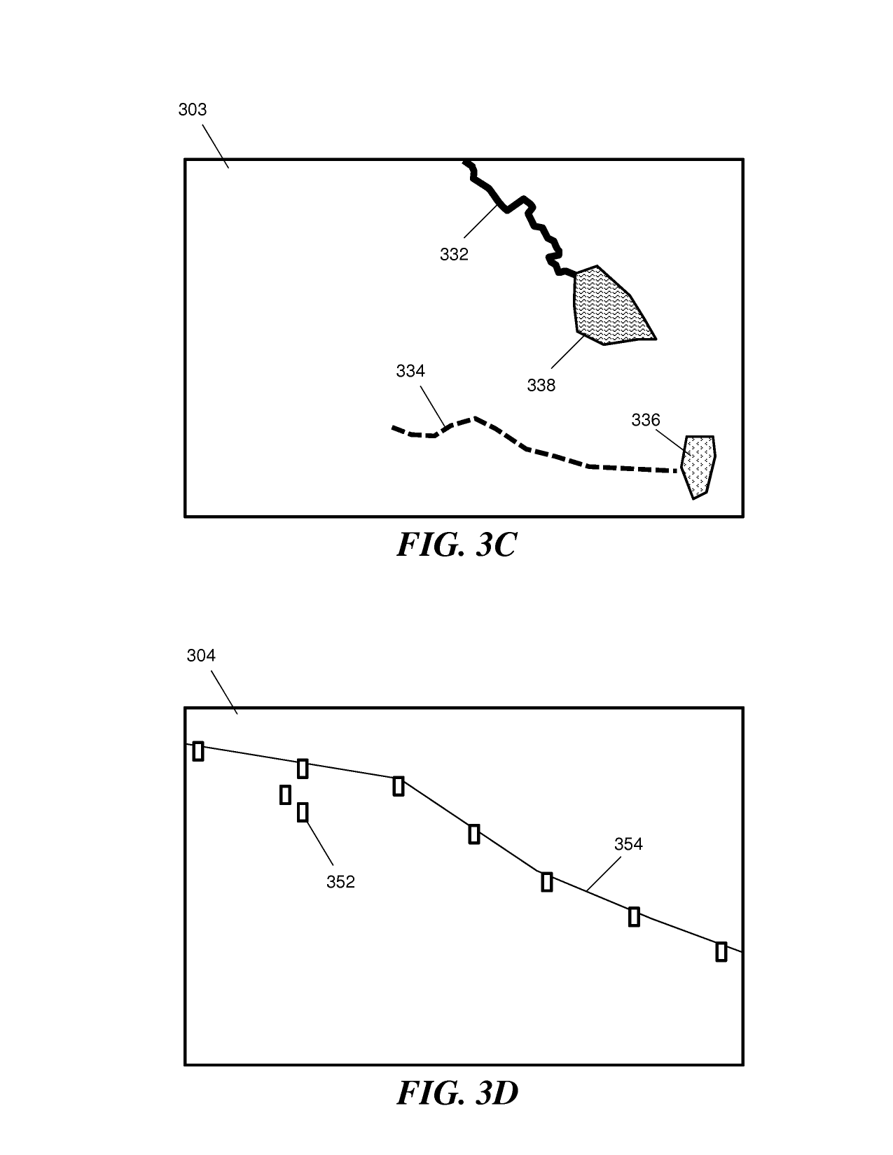

A variety of data may be utilized in the process of recognizing and identifying the one or more landing sites. In one embodiment, at least landing-zone data and ground-cover data are used to identify suitable landing sites for the aircraft. The landing-zone data may identify one or more emergency landing zones, both airfield and non-airfield, in the area in which the aircraft operates. An emergency landing zone is identified based on terrain only and is an area having enough level ground or nearly level ground suitable for landing the aircraft. Identification of an emergency landing zone may depend upon the size and type of aircraft, e.g., airplane, VTOL aircraft, or helicopter. The landing-zone data may comprise digital terrain elevation data (DTED) from which one or more emergency landing zones may be calculated. The DTED may be limited to an area in which the aircraft is intended to operate. In some embodiments, landing-zone data may comprise a list of emergency landing zones that have been calculated or pre-computed from DTED. For example, the emergency landing zones in a pre-planned flight area may be pre-computed and loaded onto the processing system 200 prior to flight of the aircraft. In some embodiments, DTED may also be used to generate a visual contour or elevation map 301, as depicted in FIG. 3A, for display on video display 110 as an aid to the pilot.

Ground-cover data may comprise information representative of the type of ground cover for the area in which the DTED is provided. Types of ground cover may include, without being limited to, trees, dense vegetation, shrubs, clear, sand, rocks, rough or uneven terrain, small buildings. Ground-cover data may be determined from images of the area, e.g., by processing satellite images or reconnaissance images to ascertain different types of ground cover in the area. In some embodiments, the aircraft may be equipped with a camera routinely obtains images of the flight area while the aircraft is in operation, so that ground-cover information can be updated regularly or semi-regularly. Ground cover data may also be displayed as a ground-cover map 302, separately or as an overlay on an elevation map. Various types of ground cover may be visibly distinguished on the map to aid the pilot. For example, the map 302 may indicate trees with a first pattern 314 and grassy areas 316 with a second pattern, as depicted in FIG. 3B. Ground-cover data may be loaded onto the processing system 200 at any time, e.g., before flight or during flight.

The ground-cover data may be used to determine first candidate emergency landing sites. These first candidate landing sites may be obtained using the emergency landing zones (calculated from DTED information, for example) that are further screened according to ground-cover data. For example, some of the emergency landing zones may be in areas covered by trees, others by rocky and uneven terrain, and some by grass. Some of the emergency landing zones may be rendered unsuitable for landing the aircraft because of the ground cover type. In some embodiments, the first candidate landing sites may be pre-computed for a pre-planned flight area, and loaded onto an aircraft prior its flight or mission.

Upon receiving an emergency landing request, processing system 200 may be configured to suspend non-critical data processing and to identify at least one candidate landing site within a current flight-capable range of the aircraft based upon the landing-zone information and ground-cover information described above. Non-critical data processing may include routine in-flight data processing, e.g., various aircraft parameter/instrument status checking and data analysis. Suspension of non-critical data processing may occur in an aircraft's processing system when the processing system is significantly taxed by in-flight processing activities and receipt of an emergency landing request would result in an appreciable delay in identifying one or more candidate landing sites to the pilot. For example, the processing system is currently taxed such that the delay in identifying the one or more landing sites may be more than about 30 seconds in some embodiments, more than about 15 seconds in some embodiments, more than about 10 seconds in some embodiments, more than about 5 seconds in some embodiments, and yet more than about 2 seconds in some embodiments. If it is determined that a delay in identifying a candidate landing site is more than a selected one one of these values, non-critical data processing may be suspended and subsequently resumed after identification of the candidate landing sites.

In some implementations, processing system 200 may be a dedicated processing system assigned only to the task of identifying candidate emergency landing sites. For example, processing system 200 may be coupled to an aircraft's main processing system, and may operate in standby mode until an emergency landing request is received by the aircraft's main processing system. The request may be relayed to processing system 200 which is subsequently activated to compute quickly one or more candidate landing sites.

Additional data may be used in the process of identifying one or more emergency landing sites. One type of additional data is hostile-threat data that identifies at least one location of a hostile installation or of hostile troops in the area of operation of the aircraft. Hostile-threat data may be updated regularly, e.g., prior to flight of the aircraft as well as during the flight of the aircraft. In some implementations, hostile-threat data may be transmitted to the aircraft while in flight so that any movement of hostile threats can be accounted for while the aircraft is in flight. Hostile-threat data may be indicated by pre-designated symbols 320 on a contour map 301 of the area, as depicted in FIG. 3A for example.

Hostile-threat information may be used to further screen candidate landing sites. For example, if a candidate emergency landing site lies within a “high-risk” or threshold distance of a hostile-threat location, then the site may be excluded as a candidate emergency landing site or it may be marked as an “unfriendly” landing site. The threshold distance may be less than an artillery range from a hostile-threat location, or may be within a direct line of site of a hostile-threat location. In some cases, the threshold distance may be a distance from the hostile-threat location that is about 25% less than a distance from an allied installation or troop location 310.

Allied-location information may also be used in the process of identifying one or more candidate emergency landing sites. Allied-location information may comprise data identifying the location(s) of one or more allied installations and/or troop locations. Allied locations 310 may be marked with pre-designated symbols on a video display as an aid to the pilot, as depicted in FIG. 3A. Candidate landing sites that are nearer to an allied location may receive a higher priority rating than candidate sites lying farther from allied locations. Allied-location data may also be updated regularly prior to flight of the aircraft as well as during flight of the aircraft, similar to hostile-threat data.

Another type of information that may be used in the process of identifying one or more candidate emergency landing sites is surface-water information. Surface-water information may comprise data identifying the location and boundaries of various types of surface waters, e.g., streams, rivers, marshes, ponds, lakes, oceans, snow, and ice. Both permanent and temporary surface waters may be identified. Different types of surface water may be indicated with different markings on a surface-water map 303 that may also be displayed to the pilot on a video display 110, as depicted in FIG. 3C. By way of example without being limiting, a first marking 332 may be used to identify a stream or river, a second marking 334 may be used to identify a temporary stream or river (e.g., a spring-time run-off or heavy rain run-off). A third marking 336 may be used to identify marshes, and a fourth marking 338 may be used to identify ponds, lakes, or oceans. The surface-water map 303 may be displayed separately or displayed as an overlay on a contour map 301, a ground-cover map 302, or a combination of these maps.

Flight-obstacle information may also be used in the process of identifying one or more candidate emergency landing sites for an aircraft. Flight-obstacle information may comprise data representative of tall structures that may present a hazard to the aircraft. Tall structures may include, without being limited to, tall buildings, towers, antennas, power lines, wind turbines, and monuments. Flight-obstacle information may be also used to screen candidate landing sites. For example, calculated candidate landing sites may be checked for their proximity to flight obstacles and excluded if the landing site lies within a “hazard” distance of a flight obstacle. A hazard distance may be any distance in which the flight obstacle may interfere with an approach or departure from the candidate landing site. Flight-obstacle data may be plotted using pre-designated symbols to indicate tall structures 352 and wires 354, as depicted in FIG. 3D for example.

Surface-water and flight-obstacle data may be stored in memory 210 accessible to the processing system in some embodiments along with other data (e.g., DTED, ground-cover, hostile-threat, and allied-location data), ready for use in determining candidate emergency landing sites by processing system 200. Since there can be a substantial amount of data to process, the data may be grouped into blocks associated with a geographical grid of the pre-planned flight area. To minimize data processing time in some embodiments, only data within a pre-designated range of the aircraft's current location may be accessed from memory 210 to determine one or more candidate emergency landing sites for the aircraft. For example, the pre-designated range might be about 20 miles, though any other value could be used (e.g., 10 miles, 5 miles, 2 miles). Further, as the aircraft travels, processing system 200 may call up data from data blocks in memory 210 associated with geographical grids lying within the pre-designated range of the aircraft, and store data from these data blocks in cache or memory that can be more rapidly accessed by processor 205b. This may allow more rapid computation of candidate emergency landing sites should an emergency landing request be received by processing system 200.

It will be appreciated that all data need not be stored and processed by processing system 200 in some embodiments. Some or a major portion of the data may be stored on a separate processing system and candidate landing sites for an entire planned flight area of the aircraft may be computed by the separate processing system prior to flight of the aircraft. Subsequently, a list of candidate landing sites may be loaded onto the processing system 200 prior to each flight or planned mission. In one embodiment, DTED, ground-cover, surface-water, and flight-obstacle information may be used to compute a list of candidate landing sites for an entire area encompassing a flight-capable range for a planned area of operation of an aircraft prior to the aircraft's departure. The list of candidate landing sites may be loaded onto processing system 200 prior to or at a beginning stage of an aircraft's flight (e.g., transmitted wirelessly to the processing system during take-off or shortly after take-off of the aircraft). While in flight, the processing system 200 may receive updated information identifying hostile-threat and allied locations. Upon receipt of an emergency landing request, processing system may retrieve a selected number of pre-computed candidate landing sites, and screen these according to the updated hostile-threat and allied location information. The processing system may then present one or more candidate emergency landing sites to the pilot for selection.

Candidate emergency landing sites may be identified to the pilot or a crew member using pre-designated symbols 330, as depicted in FIG. 3A for example. The candidate emergency landing sites may be displayed as an overlay on a contour map 301, ground-cover map, 302, surface-water map, 303, flight-obstacle map 304, or any combination of maps thereof. In some embodiments, the emergency landing site symbols may be touch sensitive on a video display 110, such that touching one of the candidate sites may invoke automatic navigation of the aircraft to the selected site.

In cases of extreme emergency, processing system 200 may be configured to place the aircraft in an emergency autopilot mode navigating towards the highest ranked candidate emergency landing site. This may occur when the processing system determines that there exists only one emergency landing site within a current flight-capable range of the aircraft and that any delays from the pilot may jeopardize the ability of the aircraft to reach the landing site. Accordingly, immediate action is needed to direct the aircraft to the landing site. The emergency autopilot mode may also alter operation of the aircraft into a fuel-conserving mode.

Candidate emergency landing sites 330 may be ranked or prioritized and numbered accordingly, as depicted in FIG. 3A. The ranking of an emergency landing site may depend on any combination of a number of factors, e.g., slope of ground, size of landing area, distance to allied location, distance from hostile-threat location, distance from flight obstacle, aircraft operational parameters. In some embodiments, candidate emergency landing sites may receive a “pre-used” designation if they have been used successfully in the past, e.g., an aircraft successfully landed and departed from the site, or a crew was successfully rescued and aircraft recovered from the site. Landing sites having a “pre-used” designation may receive preference in the ranking of landing sites or be marked differently (e.g., displayed in a different color) when displayed to the pilot.

Though FIG. 3A depicts three candidate emergency landing sites, fewer or more sites may be shown to the pilot for selection. For example, in some embodiments only two may be show, while in other embodiments, four, five, six, or more may be shown. In some embodiments, a window-of-margin time may be displayed near one or more of the candidate landing sites (shown in parentheses for the highest ranked landing site of FIG. 3A). The window-of-margin time may be calculated by processing system 200 based upon distance to the landing site and current aircraft parameters, and represent an additional or reserve amount of flying time the aircraft would have after reaching the landing site. The window-of-margin time may assist the pilot in choosing one of the candidate emergency landing sites as the emergency landing site.

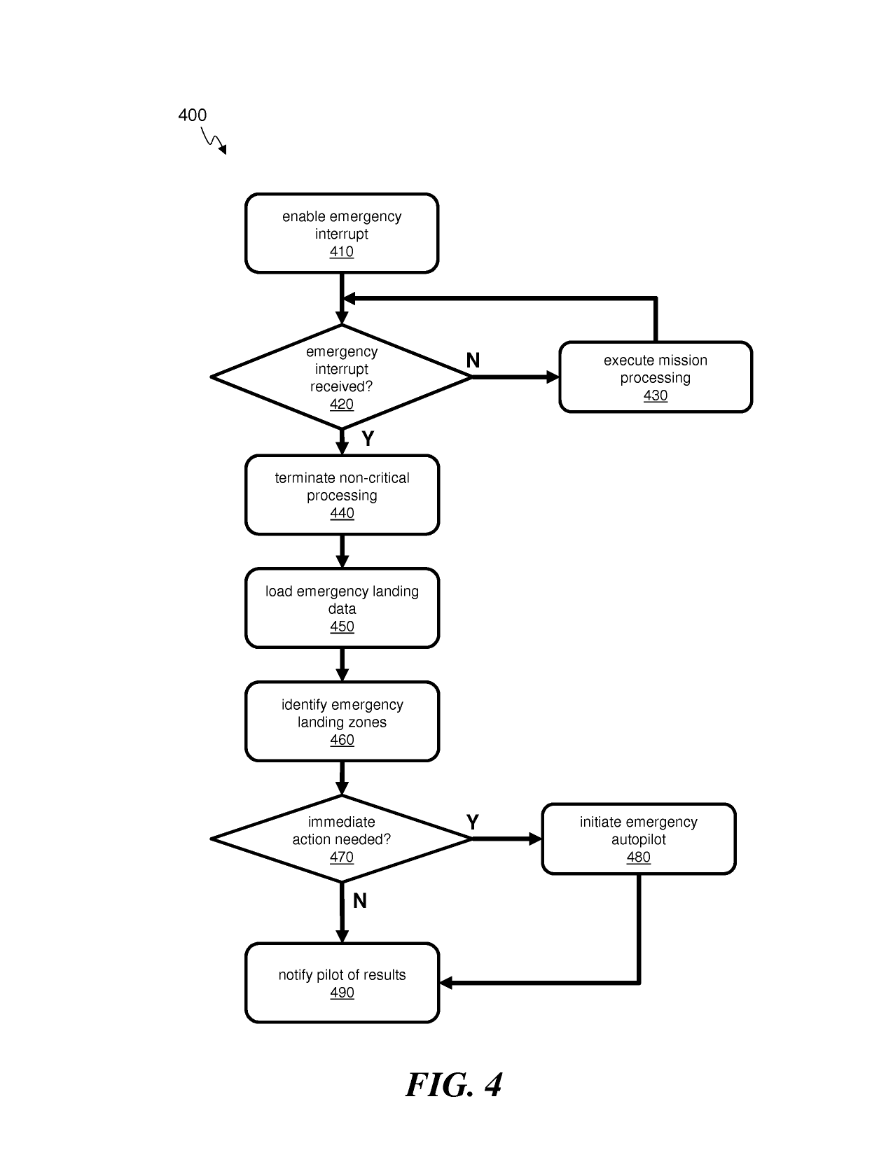

FIG. 4 represents a flow diagram of a method 400 for identifying one or more candidate emergency landing sites within a flight-capable range of an aircraft, according to one embodiment. Additional embodiments of the method may include the acts depicted in the drawing, or may include fewer or more acts than those shown. An embodiment of method 400 may begin with an act of enabling 410 an emergency interrupt on processing system 200. An emergency interrupt may be an interrupt configured on processing system 200 that listens for an emergency landing request and interrupts other processing activity to handle the emergency landing request as a first priority. The method may include repeatedly checking 420 to see if an emergency interrupt has been received, and executing 430 routine or mission processing tasks if an emergency interrupt has not been received.

Upon receipt of an emergency interrupt, method 400 may branch to an act of terminating 440 non-critical data processing by processing system 200. Processing system 200 may then retrieve 450 any emergency landing data (e.g., any combination of: DTED, ground-cover, hostile-threat, allied-location, surface-water, flight-obstacle, and candidate landing site data) that is available and can be used to calculate one or more candidate emergency landing sites. After processing the data, processing system 200 may identify 460 one or more candidate emergency landing sites suitable for landing the aircraft within a flight-capable range of the aircraft's current location. The processing system 200 may then determine 470 whether extremely urgent action is needed (e.g., only one site exists within the current flight-capable range of the aircraft with little reserve time margin). Responsive to determining that an extreme emergency exists and immediate action is necessary, processing system 200 may issue an instruction to initiate 480 emergency autopilot control of the aircraft. The processing system may then notify 490 the pilot or a crew member of at least one emergency landing site.

If it is determined 470 that immediate action and autopilot control of the aircraft is not necessary, the processing system may directly notify the pilot or a crew member of one or more candidate emergency landing sites. Processing system 200 may display a pre-selected number of the landing sites on a video monitor, so that the pilot may choose one of the candidate sites as an emergency landing site.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

The section headings used herein are for organizational purposes only and are not to be construed as limiting the subject matter described in any way.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, and/or methods, if such features, systems, and/or methods are not mutually inconsistent, is included within the inventive scope of the present disclosure.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A system for identifying at least one candidate emergency landing site for an aircraft comprising:
at least one processor configured to receive an emergency landing request;
a first data storage device storing ground-cover information identifying ground cover in a region encompassing a pre-planned flight area for the aircraft; and
the first or a different data storage device storing landing-zone information identifying at least one suitable non-airfield landing zone in the region, wherein
the at least one processor is configured to identify the at least one candidate emergency landing site within a current flight-capable range of the aircraft based at least in part upon the ground-cover information and the landing-zone information.

2. The system of claim 1, wherein upon receipt of the emergency request the at least one processor is further configured to suspend non-critical data processing to identify the at least one candidate emergency landing site.

3. The system of claim 1, wherein the at least one processor is part of a flight operational system for a helicopter or vertical take-off and landing aircraft.

4. The system of claim 1, further comprising the first or a different data storage device storing hostile-threat information identifying at least one location of a hostile installation or of hostile troops in the region, and wherein the at least one processor is further configured to identify the at least one candidate emergency landing site based further upon the hostile-threat information.

5. The system of claim 4, wherein the at least one processor is further configured to receive updated hostile-threat information during flight of the aircraft.

6. The system of claim 4, further comprising the first or a different data storage device storing surface-water information identifying at least one location of surface-water in the region, and wherein the at least one processor is further configured to identify the at least one candidate emergency landing site based further upon the surface-water information.

7. The system of claim 6, further comprising the first or a different data storage device storing flight-obstacle information identifying at least one location of a flight obstacle in the region, and wherein the at least one processor is further configured to identify the at least one candidate emergency landing site based further upon the flight-obstacle information.

8. The system of claim 1, wherein the at least one processor is further configured to:
receive status information representative of aircraft flight operational systems; and
provide an interactive emergency landing zone indicator to a pilot of the aircraft responsive to the at least one processor determining that received status information may necessitate an emergency landing of the aircraft.

9. A method for identifying at least one candidate emergency landing site for an aircraft, the method comprising:
receiving, by at least one processor, an emergency landing request; and
identifying, by the at least one processor, at least one candidate non-airfield emergency landing site within a current flight-capable range of the aircraft based at least in part upon landing-zone information and ground-cover information descriptive of a region encompassing a pre-planned flight area of the aircraft.

10. The method of claim 9, further comprising suspending, by the at least one processor, non-critical data processing while identifying the at least one candidate non-airfield emergency landing site.

11. The method of claim 9, wherein the at least one processor is part of a flight operational system for a helicopter or vertical take-off and landing aircraft.

12. The method of claim 9, wherein the ground-cover information is representative of at least one type of ground cover selected from the following list: trees, dense vegetation, grass, sand, rocks, craters, uneven terrain.

13. The method of claim 9, wherein the landing-zone information identifies locations suitable for landing the aircraft that have been calculated from digital terrain elevation data.

14. The method of claim 9, wherein the emergency landing request is issued by a pilot of the aircraft.

15. The method of claim 9, wherein the emergency landing request is issued by the at least one processor responsive to the at least one processor determining from received status information that an emergency landing of the aircraft may be necessary.

16. The method of claim 9, further comprising receiving, by the at least one processor, updated hostile-threat and/or allied-location information during flight of the aircraft.

17. The method of claim 16, wherein the identifying the at least one candidate emergency non-airfield landing site is further based upon hostile-threat information.

18. The method of claim 17, wherein the identifying the at least one candidate emergency non-airfield landing site is further based upon flight-obstacle and/or surface-water information.

19. The method of claim 17, further comprising:
receiving, by the at least one processor, status information representative of aircraft flight operational systems;
determining from the received status information whether or not an emergency landing of the aircraft is necessary; and
providing an interactive emergency landing zone indicator to a pilot of the aircraft responsive to determining that an emergency landing of the aircraft is necessary.

20. At least one manufactured storage device storing machine-readable instructions that, when executed by at least one processor, adapt the at least one processor to execute acts of:
receiving, by at least one processor, status information representative of aircraft flight operational systems;
calculating, by the at least one processor, a current flight-capable range of the aircraft based on the received status information;
determining, by the at least one processor, that an emergency landing of the aircraft is necessary responsive to detecting an increase in the rate of reduction of the aircraft's flight-capable range that exceeds a pre-determined value;
receiving, by at least one processor, an emergency landing request; and
identifying, by the at least one processor, at least one candidate emergency non-airfield landing site within the current flight-capable range of the aircraft based at least in part upon landing-zone information and ground-cover information within a region encompassing a pre-planned flight area of the aircraft.

21. The at least one manufactured storage device of claim 20, further storing instructions to adapt the at least one processor to execute act of:
suspending, by the at least one processor, non-critical data processing while identifying the at least one candidate emergency non-airfield landing site.

22. The at least one manufactured storage device of claim 20, further storing instructions to adapt the at least one processor to execute act of:
identifying further, by the at least one processor, the at least one candidate emergency non-airfield landing site based upon hostile-threat information and/or surface-water information.

23. The at least one manufactured storage device of claim 20, wherein the at least one processor is part of a flight operational system for a helicopter or vertical take-off and landing aircraft.
